(19) United States
(12) Patent Application Publication
(10) Pub. No.: US 2007/0250717 A1
(43) Pub. Date: Oct. 25, 2007

(54) Image forming apparatus, image reproducing apparatus and image processing system

(76) Inventors: Kazuyuki Kumagai, Tokyo (JP); Manabu Nakamura, Kanagawa (JP); Takehito Kuroko, Kanagawa (JP)

Correspondence Address: COOPER & DUNHAM, LLP, 1185 AVENUE OF THE AMERICAS, NEW YORK, NY, 10036, US

(21) Appl. No.: 11/787,706

(22) Filed: Apr. 16, 2007

(30) Foreign Application Priority Data
Apr. 20, 2006 (JP) 2006-116942

(51) Int. Cl. H04L 9/00

(52) U.S. Cl. 713/176

(57) ABSTRACT

An image forming apparatus is provided with a first generating part to generate an encrypted image data by subjecting an input image data to a predetermined encryption process, a second generating part to generate a decryption key that is used when decrypting the encrypted image data, wherein a different decryption key is generated every time the encrypted image data is generated, and an identifier that is uniquely determined based on the encrypted image data is generated. An outputting part is further provided to form decryption key information by adding the identifier to the decryption key, and to store the decryption key information in a removable storage medium that is connected to the image forming apparatus.

### BACKGROUND OF THE INVENTION

1. Field of the Invention

The present invention generally relates to image forming apparatuses, image reproducing apparatuses and image processing systems, and more particularly to an image forming apparatus for generating a common key of a common key cryptosystem and encrypted image data using the common key, an image reproducing apparatus for reproducing the original image data by decrypting the encrypted image data using the common key, and an image processing system which includes such an image forming apparatus and such an image reproducing apparatus. The present invention also relates to a method of controlling such an image processing system.

2. Description of the Related Art

Recently, paperless systems are employed in offices, and documents read by image forming apparatuses having a scanner function are formed into electronic document data. In addition, functions of sending the electronic document data to a client personal computer (PC) or a file server are used.

However, the electronic document data that is obtained by scanning the document by the scanner function may be subjected to unauthorized or illegal modification, or tampering of contents.

In addition, when the electronic document data is transferred via a network, the information of the electronic document data may leak to a third party by interception of the electronic document data within the network.

Accordingly, proposals have been made to prevent the information leak by encrypting the electronic document data.

For example, a Japanese Patent No. 3616601 proposes an image forming apparatus that obtains the electronic document data by scanning the document in the image forming apparatus, adds an electronic signature to the electronic document data by using a secret key stored in an external storage medium that is connected to the image forming apparatus, and sends the electronic document data with the electronic signature to a data processing apparatus that is connected to the image forming apparatus via a network.

But according to the image forming apparatus proposed in the Japanese Patent, No. 3616601, the user must carry out the troublesome operations of generating the pair of secret key and public key in advance, storing the secret key in the external storage medium, and connecting the external storage medium to the image forming apparatus.

Moreover, if the user loses the external storage medium that stores the secret key, an unauthorized or illegal use of the secret key may be made by a third party who obtains the external storage medium.

### SUMMARY OF THE INVENTION

Accordingly, it is a general object of the present invention to provide a novel and useful image forming apparatus, image reproducing apparatus, image processing system, and method of controlling the image processing system, in which the problems described above are suppressed.

Another and more specific object of the present invention is to provide an image forming apparatus, an image reproducing apparatus, an image processing system, and a method of controlling the image processing system, which can prevent easy tampering of electronic data and prevent information leak.

Still another object of the present invention is to provide an image forming apparatus comprising a first generating part configured to generate an encrypted image data by subjecting an input image data to a predetermined encryption process; a second generating part configured to generate a decryption key that is used when decrypting the encrypted image data, said second generating part generating a different decryption key every time the encrypted image data is generated, and generating an identifier that is uniquely determined based on the encrypted image data; and an outputting part configured to form decryption key information by adding the identifier to the decryption key, and to store the decryption key information in a first removable storage medium that is connected to the image forming apparatus. According to the image forming apparatus of the present invention, it is possible to prevent easy tampering of electronic data and prevent information leak.

A further object of the present invention is to provide an image reproducing apparatus comprising an input part configured to receive encrypted image data and decryption key information by reading at least one of the encrypted image data and the decryption key information from a removable storage medium; a storage unit configured to store the decryption key information; a generating part configured to generate an identifier that is uniquely determined based on the encrypted image data; a decrypting part configured to decrypt the encrypted image data using a decryption key of the decryption key information that corresponds to the identifier and to reproduce an original image data; and an output part configured to output the original image data. According to the image reproducing apparatus of the present invention, it is possible to prevent easy tampering of electronic data and prevent information leak.

Another object of the present invention is to provide an image processing system comprising an image forming apparatus comprising a first generating part configured to generate an encrypted image data by subjecting an input image data to a predetermined encryption process; a second generating part configured to generate a decryption key that is used when decrypting the encrypted image data, said second generating part generating a different decryption key every time the encrypted image data is generated, and generating an identifier that is uniquely determined based on the encrypted image data; and an outputting part configured to form decryption key information by adding the identifier to the decryption key, and to store the decryption key information in a first removable storage medium that is connected to the image forming apparatus; and an image reproducing apparatus, connectable to the image forming apparatus via a network, comprising an input part configured to receive the encrypted image data and the decryption key information by receiving the encrypted image data sent from the image forming apparatus and reading at least the decryption key information from the first removable storage medium that is connected to the image reproducing apparatus; a storage unit configured to store the decryption key information; a generating part configured to generate an identifier that is uniquely determined based on the encrypted image data; a decrypting part configured to decrypt the encrypted image data using a decryption key of the decryption key information that corresponds to the identifier and to reproduce an original image data; and an output part configured to output the original image data. According to the image processing system of the present invention, it is possible to prevent easy tampering of electronic data and prevent information leak.

Other objects and further features of the present invention will be apparent from the following detailed description when read in conjunction with the accompanying drawings.

### BRIEF DESCRIPTION OF THE DRAWINGS

FIG. 1 is a system block diagram showing a network system in one embodiment of the present invention;

FIG. 2 is a system block diagram showing a structure of a multifunction peripheral;

FIG. 3 is a system block diagram showing a structure of a work station apparatus;

FIG. 4 is a diagram for explaining an encryption method according to a common key cryptosystem;

FIG. 5 is a diagram for explaining an encryption method using an encryption key and a decryption key in conformance with a public key system;

FIGS. 6A through 6C are diagram for explaining decryption key information;

FIG. 7 is a flow chart for explaining a process of the multifunction peripheral;

FIG. 8 is a diagram showing an output destination selection screen;

FIG. 9 is a flow chart for explaining a process of the work station apparatus when a transfer request for encrypted image data from the multifunction peripheral is received via a local area network;

FIG. 10 is a flow chart for explaining a process of the work station apparatus when an instruction is received from the user to store decryption key information read from an USB memory device;

FIG. 11 is a flow chart for explaining a process of the work station apparatus when an instruction is received from the user to read encrypted image data from the USB memory device; and

FIG. 12 is a flow chart for explaining another process of the multifunction peripheral.

### DESCRIPTION OF THE PREFERRED EMBODIMENTS

A description will be given of embodiments of the image forming apparatus, the image reproducing apparatus, the image processing system, and the method of controlling the image processing system according to the present invention, by referring to the drawings.

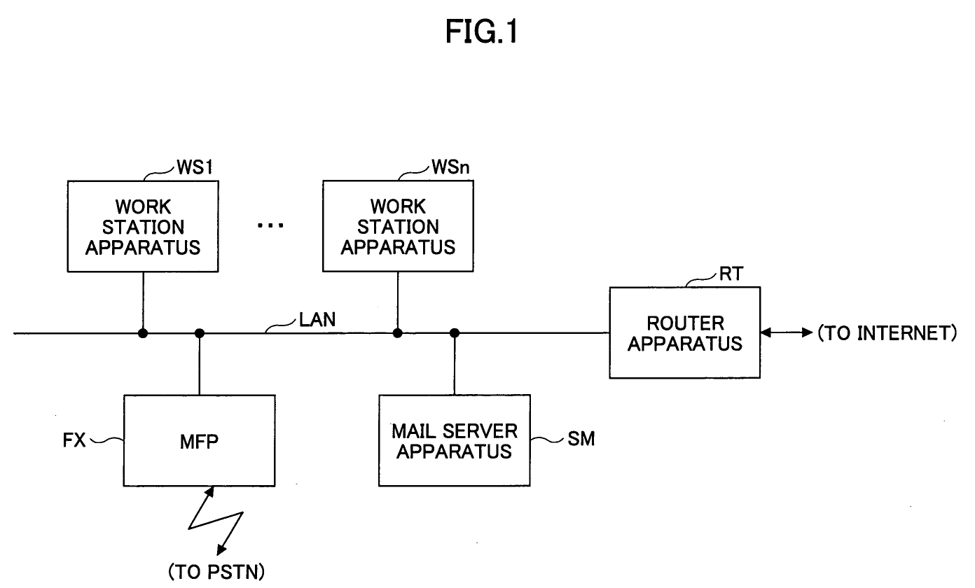

FIG. 1 is a system block diagram showing a network system in one embodiment of the present invention.

In FIG. 1, a plurality of work station apparatuses WS1 through WSn, a mail server apparatus SM, and a multifunction peripheral (MFP) FX are connected to a local area network LAN. The LAN is connected to the Internet via a router apparatus RT. Accordingly, the work station apparatuses WS1 through WSn, the mail server apparatus SM and the MFP FX can exchange data with another suitable data terminal apparatus via the Internet. The MFP is sometimes also referred to as a composite apparatus, and includes a plurality of functions selected from a printer function, a scanner function, a copying function, a facsimile function and the like.

The mail server apparatus SM provides known electronic mail collecting and distributing services with respect to the user who uses the work station apparatuses WS1 through WSn that are connected to the local are network LAN, and with respect to the MFP FX.

Various programs are implemented in the work station apparatuses WS1 through WSn, such as a software for inputting and processing encrypted image data and decrypted (or decoded) key information output from the MFP FX, a facsimile application software for creating, displaying and outputting facsimile image information, and a communication software for exchanging various data with the MFP FX via the local area network LAN. The work station apparatuses WS1 through WSn are used by at least one specific (or specified) user. In this embodiment, there may only be one specific user or, may be a plurality of specific users.

The MFP FX includes an encrypted image data distributing function for encrypting image data that is obtained by reading a document image and distributing the encrypted image data to the work station apparatuses WS1 through WSn, an electronic mail processing function for exchanging image information, various reports and the like in the form of electronic mail, and a transmitting function for connecting to an analog public line network (or public switch telephone network) PSTN and transmitting image information according to a Group-3 facsimile transmission procedure using the public line network as a transmission path.

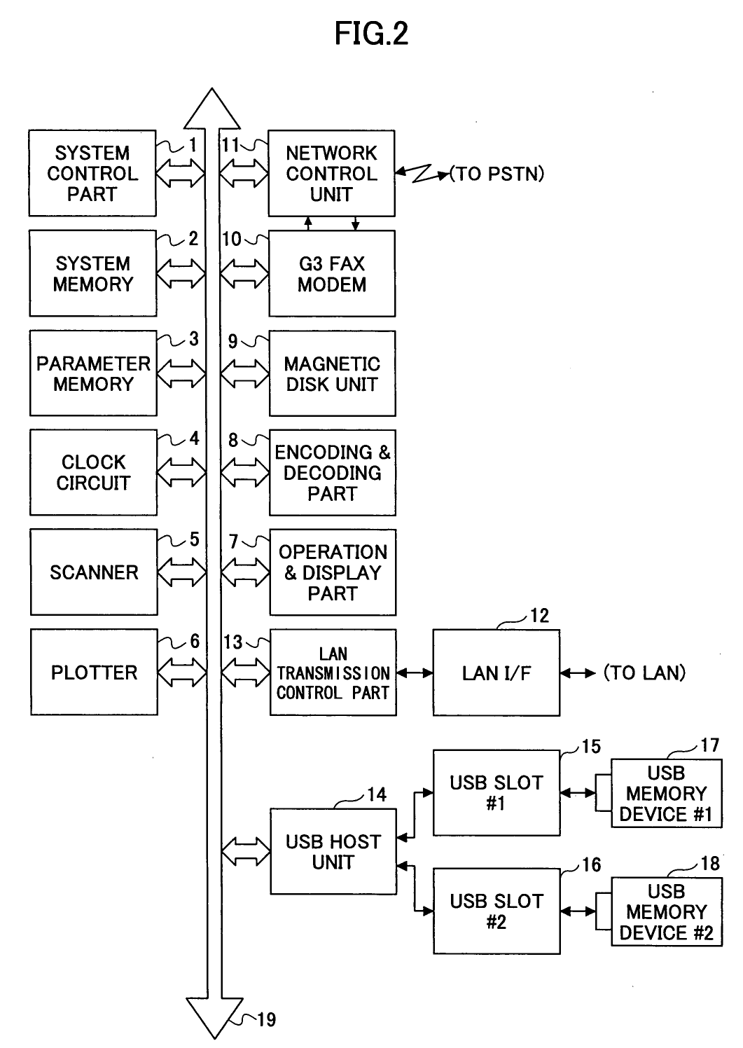

FIG. 2 is a system block diagram showing a structure of the MFP FX.

In FIG. 2, a system control part 1 carries out various control processes such as a control process to control various parts of the MFP FX, an encryption process and a facsimile transmission control procedure process. A system memory 2 stores control process programs to be executed by the system control part 1, and various data that are required when executing the process programs, and also forms a work area for the system control part 1. The system memory 2 is made up of a read only memory (ROM) and a random access memory (RAM). A parameter memory 3 stores various information peculiar to the MFP FX, and is made up of a nonvolatile RAM (NV-RAM) or the like. A clock circuit 4 outputs present time information.

A scanner 5 reads the document image at a predetermined resolution, and is provided with an automatic document feed (ADF) unit. A plotter 6 records the image at a predetermined resolution. An operation and display part 7 is operated by the user to operate the MFP FX, and includes various operation keys and various displays or indicators.

An encoding and decoding (or codec) part 8 carries out the operations of encoding and compressing the image signal and decoding and expanding the encoded and compressed image information back into the original image signal. A magnetic disk unit 9 stores various image information in the encoded and compressed state, and various data such as the decryption key information.

A Group-3 facsimile modem 10 realizes a modem function of the Group-3 facsimile apparatus. The Group-3 facsimile modem 10 includes a low-speed modem (V.21 modem) function for exchanging transmission procedure signals, one or more high-speed modem (V.17 modem, V.34 modem, V.29 modem, V.27ter modem, etc.) functions for mainly exchanging image information.

A network control unit 11 connects the MFP FX to the analog public line network (or public switch telephone network) PSTN, and is provided with automatic call forwarding and receiving functions.

A local area network interface (LAN I/F) circuit 12 connects the MFP FX to the local area network LAN. A local area network (LAN) transmission control part 13 executes communication control processes of various protocol suites for exchanging various data with other data terminal apparatuses via the local area network LAN.

An USB host unit 14 realizes functions such as a data storage by USB, and is provided with two USB slots 15 and 16. Freely detachable USB memory devices 17 and 18 may be inserted into the USB slots 15 and 16, so as to use the USB memory devices 17 and 18 as external storage units.

The system control part 1, the system memory 2, the parameter memory 3, the clock circuit 4, the scanner 5, the plotter 6, the operation and display part 7, the encoding and decoding part 8, the magnetic disk unit 9, the Group-3 facsimile modem 10, the network control unit 11, the LAN transmission control part 13 and the USB host unit 14 described above are connected to an internal bus 19. Exchange of data among the system control part 1, the system memory 2, the parameter memory 3, the clock circuit 4, the scanner 5, the plotter 6, the operation and display part 7, the encoding and decoding part 8, the magnetic disk unit 9, the Group-3 facsimile modem 10, the network control unit 11, the LAN transmission control part 13 and the USB host unit 14 is mainly made via this internal bus 19.

In addition, the exchange of data is made directly between the network control unit 11 and the Group-3 facsimile modem 10.

In this embodiment, the exchange of data between the MFP FX and the data terminal apparatus that is connected to the local area network LAN is basically made by applying a combination (so-called protocol suite) of the transmission protocol, which is called the TCP/IP, up to the transport layer, and the communication protocol in the upper layer. For example, the communication protocol called the SMTP (Simple Mail Transfer Protocol) is applied, as the communication protocol in the upper layer, to the exchange of data of electronic mails.

It is possible to apply the so-called POP (Post Office Protocol) or the like when each data terminal apparatus makes an acquisition request, a reception confirmation (or acknowledge request) and the like for the electronic mail addressed to the user, with respect to the mail server apparatus SM.

In addition, the communication protocol, such as the TCP/IP, SMTP and POP, and the data format and the data structure of the electronic mail are prescribed by the RFC document that is issued by the IETF. For example, the TCP is prescribed by RFC 793, the IP is prescribed by RFC 793, the SMTP is prescribed by RFC 821, and the electronic mail format is prescribed by RFC 822, RFC 1521, RFC 1522 (MIME (Multi Purpose Mail Extension) format) and the like.

The encoding and decoding part 8 forms a first generating part (or means) configured to generate an encrypted image data by subjecting an input image data to a predetermined encryption process, a second generating part (or means) configured to generate a decryption key that is used when decrypting the encrypted image data, where the second generating part generates a different decryption key every time the encrypted image data is generated and generates an identifier that is uniquely determined based on the encrypted image data, and an outputting part (or means) configured to form decryption key information by adding the identifier to the decryption key, and to store the decryption key information in a removable storage medium such as the USB memory device 17 or 18 that is connected to the MFP FX. This outputting part (or means) may be formed by the system control part 1 or, formed by a combination of the system control part 1 and the encoding and decoding part 8.

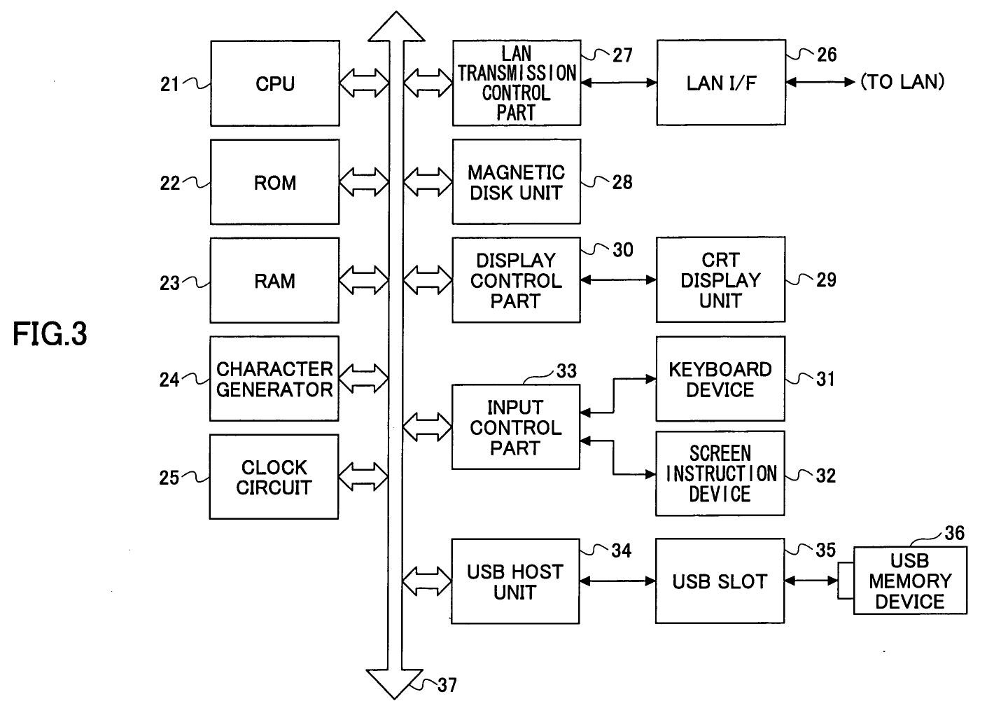

FIG. 3 is a system block diagram showing a structure of a work station apparatus WS which may be used as each of the work station apparatuses WS1 through WSn.

In FIG. 3, a central processing unit (CPU) 21 controls the general operation of the work station apparatus WS. A ROM 22 stores programs executed by the CPU 21 when the CPU 21 is started, necessary data and the like. A RAM 23 forms a work area or the like of the CPU 21.

A character generator 24 generates display data of graphic characters. A clock circuit 25 outputs present date and time information. A local area network interface (LAN I/F) circuit 26 connects the work station apparatus WS to the local area network LAN. A local area network (LAN) transmission control part 27 executes communication control processes of various protocol suites for exchanging various data with other data terminal apparatuses via the local area network LAN.

A magnetic disk unit 28 stores various application programs such as a Web browser, and various data such as work data, file data, decryption key information, encrypted image data and image information data. A CRT display unit 29 displays screens for operating the work station apparatus WS and the like. A display control part 30 controls display contents of the CRT display unit 29.

A keyboard device 31 is manipulated by the user to input various instructions and information to the work station apparatus WS by key operations. A screen instruction device 32 is manipulated by the user to instruct or specify an arbitrary position on the screen of the CRT display unit 29. For example, the screen instruction device 32 may be made up of a mouse. An input control part 33 inputs information that is input from the keyboard device 31 and the screen instruction device 32 to the work station apparatus WS.

An USB host unit 34 realizes functions such as a data storage by USB, and is provided with a single USB slot 35. A freely detachable USB memory device 36 may be inserted into the USB slot 35, so as to use the USB memory device 36 as an external storage unit.

The CPU 21, the ROM 22, the RAM 23, the character generator 24, the clock circuit 25, the LAN transmission control part 27, the magnetic disk unit 28, the display control part 30, the input control part 33 and the USB host unit 34 are connected to a bus 37. Exchange of data among the CPU 21, the ROM 22, the RAM 23, the character generator 24, the clock circuit 25, the LAN transmission control part 27, the magnetic disk unit 28, the display control part 30, the input control part 33 and the USB host unit 34 is mainly made via this bus 37.

The USB host unit 34 forms an input part (or means) configured to receive encrypted image data and decryption key information by reading at least the decryption key information from a removable storage medium that is connected to the image reproducing apparatus. The input part (or means) may be formed by the USB host unit 34, the LAN interface 26 and the LAN transmission control part 27 when receiving the encrypted image data via the local area network LAN.

The magnetic disk unit 28 forms a storage unit (or means) configured to store the decryption key information.

The CPU 21 forms a generating part (or means) configured to generate an identifier that is uniquely determined based on the encrypted image data, and a decrypting part (or means) configured to decrypt the encrypted image data using a decryption key of the decryption key information that corresponds to the identifier and to reproduce an original image data.

The CPU 21 also forms an output part (or means) configured to output the original image data. The output part (or means) may be formed by the display control part 30 and the CRT display unit 29 when displaying the original image data, and may be formed by the LAN transmission control part 27 and the LAN interface 26 when outputting the original image data to the local area network LAN.

In this embodiment, the MFP FX encrypts the image data that is obtained by reading the document image by the scanner 5, and stores the encrypted image data in the USB memory device 17 or the USB memory device 18. Alternatively, the MFP FX transfers the encrypted image data to the work station apparatus WS via the local area network LAN, generates the decryption key information that is required when decrypting the encrypted image data, and stores the decryption key information in the USB memory device 18 or the USB memory device 17. In addition, identification information, which identifies the corresponding encrypted image data, is added to the decryption key information. The decryption key information will be described later in more detail.

On the other hand, in the work station apparatus WS, the USB memory device 17 or 18 that stores the encrypted image data or the decryption key information is inserted into the USB slot 35, and the USB memory device 17 or 18 is used as the external storage unit of the work station apparatus WS.

The work station apparatus WS reads the encrypted image data or the decryption key information that is stored in the USB memory device 17 or 18, and stores the read encrypted image data or decryption key information in the magnetic disk unit 28.

The user of the work station apparatus WS manipulates the keyboard device 31 or the screen instruction device 32 to display on the CRT display unit 29 a list of encrypted image data that are stored in the magnetic disk unit 28, for example, and selects the encrypted image data that is to be displayed and output.

Accordingly, the work station apparatus WS creates the identification information of the decryption key, and searches for the decryption key information having this identification information from the plurality of decryption key information stored in the magnetic disk unit 28.

When the decryption key information having this identification information is found by the search, a decryption process (or decoding process) is carried out with respect to the selected encrypted image data using the decryption key that is included in the decryption key information that is found. The original image data that is obtained by the decryption process is displayed on the CRT display unit 29 and output.

Therefore, in this embodiment, a different encryption key is generated every time the image data is read, and the generated encryption key is used to encrypt the read image data. The encrypted image data is stored in the USB memory device or, stored in a storage region of the specified work station apparatus WS. In addition, the decryption key information that is required when carrying out the decryption process is stored in the USB memory device.

Furthermore, the encryption key that is used for the encryption process is a kind of expendable encryption key, and is generated with respect to each image data that is the target of the encryption process. As a result, a large number of decryption key information are stored in the USB memory device. Hence, the identification information, which can relate each encrypted image data with the corresponding decryption key information that is required for the decryption process, is generated and added to or, included in the decryption key information.

Next, a description will be given of the encryption method used by the MFP FX.

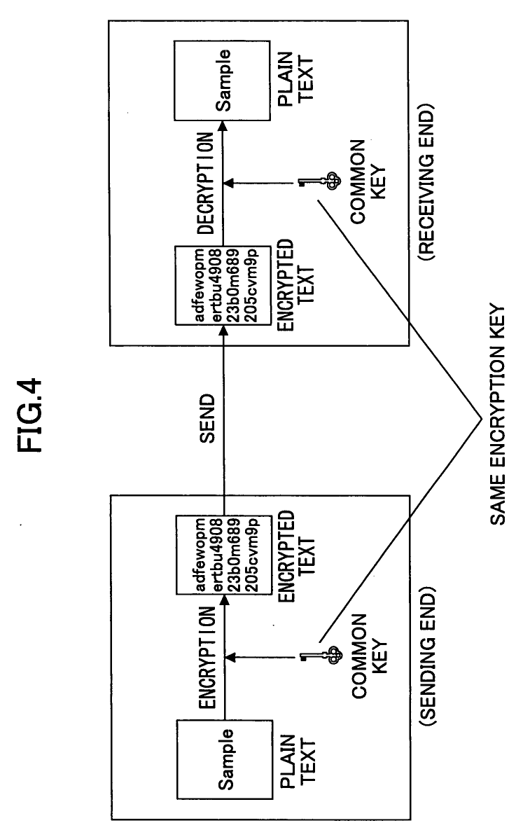

This embodiment uses an encryption method according to a common key cryptosystem shown in FIG. 4 or, an encryption method using an encryption key and a decryption key in conformance with a public key system shown in FIG. 5. The same key (common key) is used for the encryption process and the decryption process in the case of the encryption method according to the common key cryptosystem, and the decryption key in this case is the common key. On the other hand, in the case of the encryption method using the encryption key and the decryption key in conformance with the public key system, the decryption key which forms a pair with the encryption key is generated, the encryption key is used for the encryption process, and the decryption key is used for the decryption process.

Of course, any suitable encryption method and decryption method may be employed for the encryption process and the corresponding decryption process.

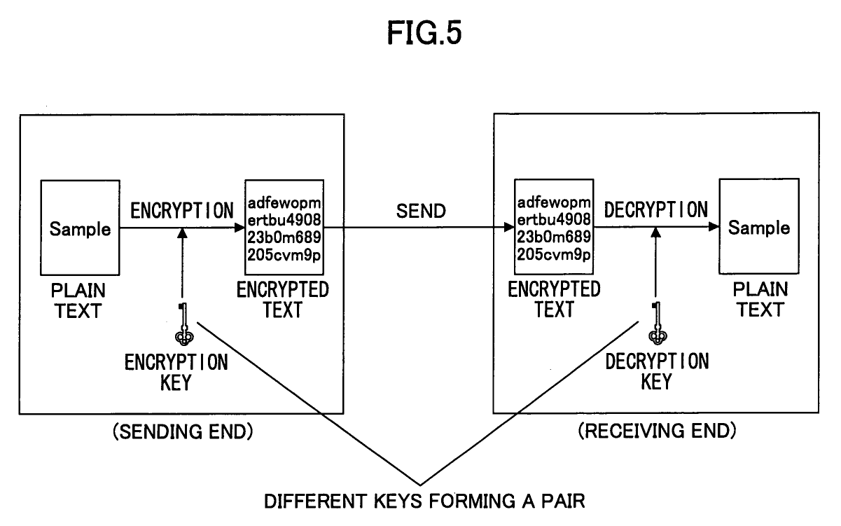

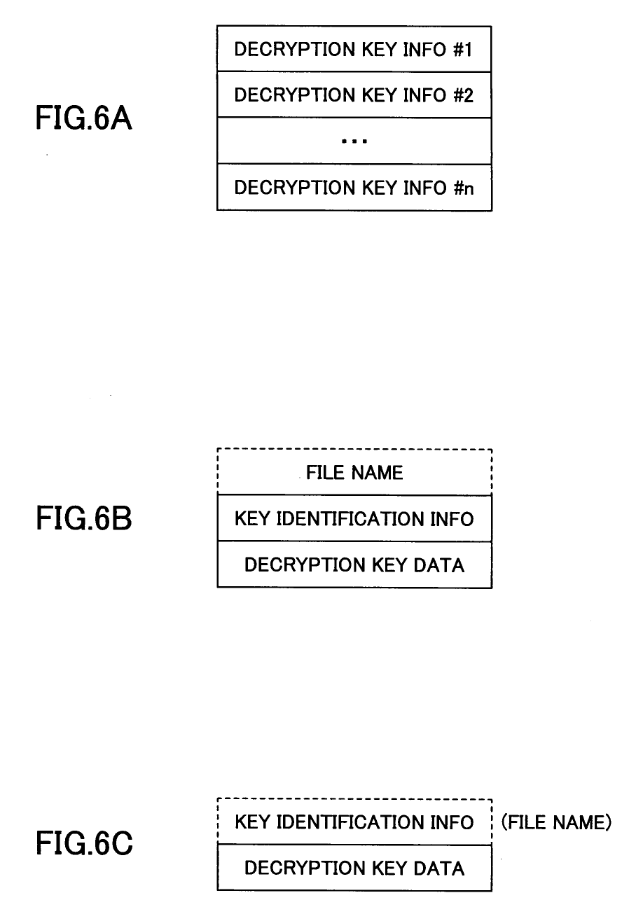

FIGS. 6A through 6C are diagram for explaining the decryption key information.

As shown in FIG. 6A, a plurality of decryption key information #1 through #n are stored in the USB memory device. The plurality of decryption key information #1 through #n are stored in a decryption key storage region of the USB memory device.

As shown in FIG. 6B, each decryption key information includes a file name and a main file body. The file name indicates identification information that is required to identify each file in the file system of the USB memory device. The main file body includes key identification information that is used to identify a correspondence between the concerned decryption key information and the corresponding encrypted image data, and decryption key data that forms a main body of the decryption key.

Alternatively, each decryption key information includes key identification information and decryption key data, as shown in FIG. 6C. The key identification information is provided as a file name, and is used to identify a correspondence between the concerned decryption key information and the corresponding encrypted image data. The decryption key data is provided as a main file body, and forms a main body of the decryption key. In this case, the key identification information is formed by a number of digits and character type in accordance with the format of the file name which is applicable to the file system of the USB memory device.

The method of generating the common key may create binary data having a number of bits required for the encryption process. Basically, a predetermined number of bits of data is used as seed data, and the binary data having the required number of bits is generated from the seed data by applying thereto a random number function.

For example, date and time data, a predetermined number of bits of data extracted from the image data (the extracting location may be an offset address which indicates a starting point and corresponds to a random number that is generated from the seed data such as the date and time and the file name), a predetermined number of bits of data generated from the image data by applying thereto a message digest generating function, and the like may be used as the seed data.

On the other hand, when generating both the encryption key and the decryption key, it is possible to employ a method similar to that employed to generate the common key.

A predetermined number of bits of data that is formed by applying a predetermined hash function (message digest generating function) with respect to the encrypted image data, may be used as the key identification information. For example, the MD5 or the SHA-1 may be used as the hash function.

As another example of the key identification information, the generated date and time of the file may be attached to the file name and used as the key identification information, for example.

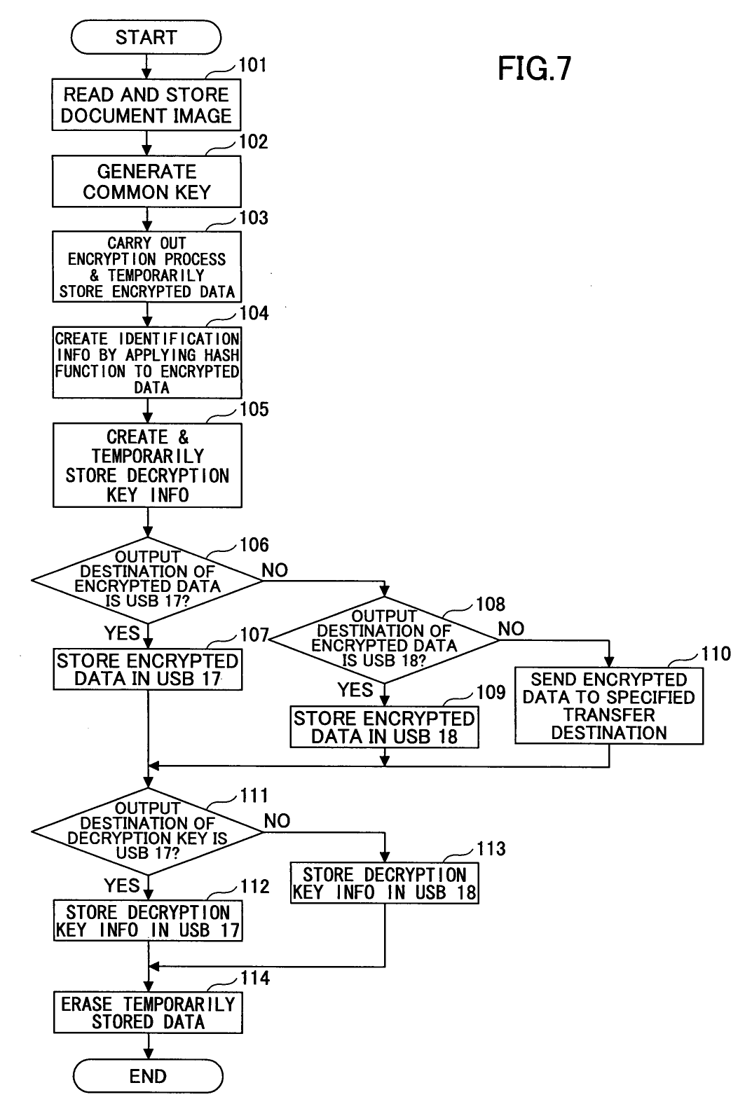

FIG. 7 is a flow chart for explaining a process of the MFP FX. In this case, the common key cryptosystem is used as the encryption method.

When the user instructs a document read, the image of the reading document that is set on the scanner 5 is read, and the read image data is temporarily stored in the magnetic disk unit 9 (process 101). Then, the common key is generated by the method described above, and is temporarily stored in the parameter memory 3 or the magnetic disk unit 9 (process 102).

Next, the generated common key is used to carry out the encryption process with respect to the read image data, and the encrypted image data is temporarily stored in the magnetic disk unit 9 (process 103).

The hash function is applied to the encrypted image data to generate the identification information (process 104), and the decryption key information described above is created and temporarily stored in the parameter memory 3 of the magnetic disk unit 9 (process 105).

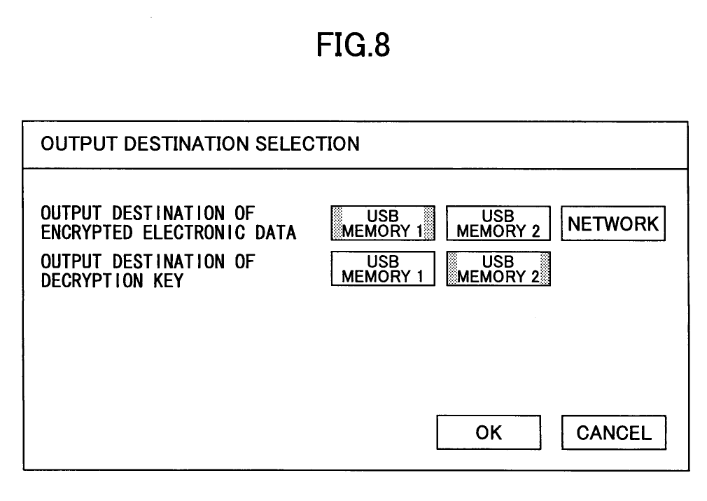

Next, an output destination selection screen shown in FIG. 8 is displayed on the operation and display part 7, and urges the user to select the storage locations of the encrypted image data and the decryption key (output destination of the encrypted image data and the output destination of the decryption key). If the “network” is selected as the storage location of the encrypted image data, the user is urged to input the network address of the storage location (for example, the network folder name of the shared storage region in the magnetic disk unit 28 of the work station apparatus WS1).

Thereafter, a judgment is made to determine whether or not the USB memory device 17 is selected as the output destination of the encrypted image data (judgment 106), and if the result of the judgment 106 is YES, the encrypted image data is stored in the USB memory device 17 (process 107).

In addition, if the result of the judgment 106 is NO, a judgment is made to determine whether or not the USB memory device 18 is selected as the output destination of the encrypted image data (judgment 108), and if the result of the judgment 108 is YES, the encrypted image data is stored in the USB memory device 18 (process 109).

If the result of the judgment 108 is NO, it means that the network is selected as the output destination of the encrypted image data. Hence, the encrypted image data is transferred to the specified network address via the local area network LAN (process 110).

Next, a judgment is made to determine whether or not the USB memory device 17 is selected as the output destination of the decryption key (judgment 111), and if the result of the judgment 111 is YES, the decryption key information is stored in the USB memory device 17 (process 112).

In addition, if the result of the judgment 111 is NO, it means that the USB memory device 18 is selected as the output destination of the decryption key. Hence, the decryption key information is stored in the USB memory device 18 (process 113).

When the storage of the encrypted image data and the decryption key information ends, the temporarily stored encrypted image data and decryption key information are erased (process 114), and the process ends.

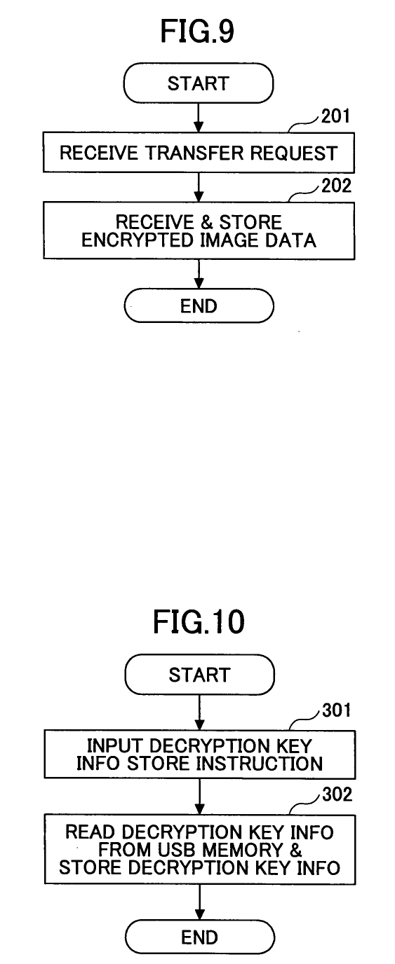

FIG. 9 is a flow chart for explaining a process of the work station apparatus WS when a transfer request for encrypted image data from the MFP FX is received via the local area network LAN.

When the transfer request is received (process 201), the encrypted image data is received and stored in the magnetic disk unit 28 (process 202).

FIG. 10 is a flow chart for explaining a process of the work station apparatus WS when an instruction is received from the user to store the decryption key information that is read from the USB memory device 36. This process shown in FIG. 10 may be automatically started when the USB memory device 36 is inserted into the USB slot 35.

When the decryption key information store instruction is input (process 301), the decryption key information is read from the USB memory device 36 and stored in the magnetic disk unit 28 (process 302).

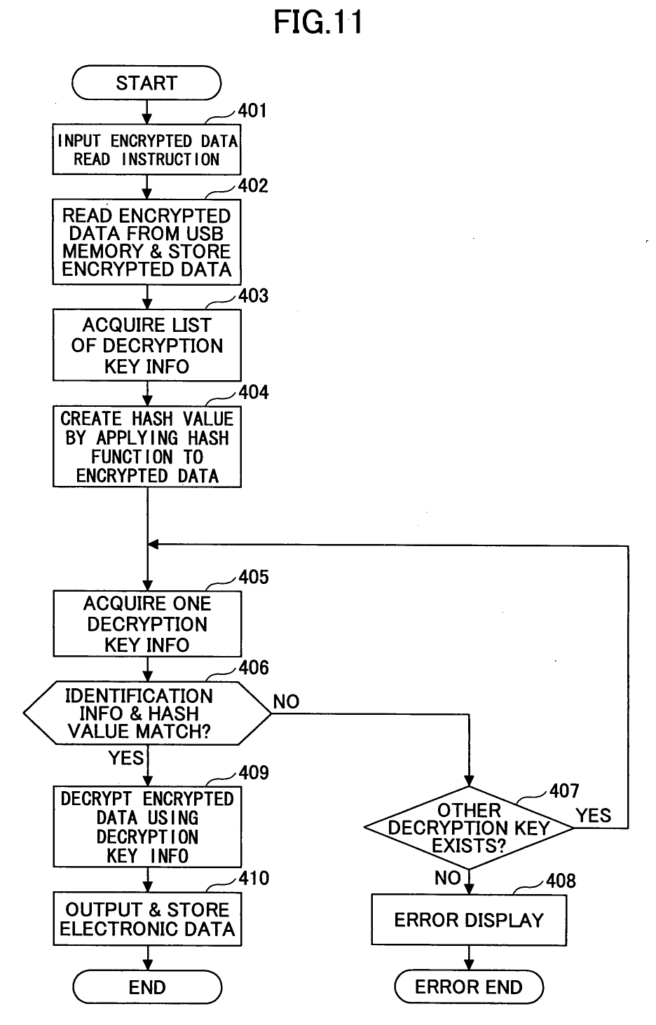

FIG. 11 is a flow chart for explaining a process of the work station apparatus WS when an instruction is received from the user to read the encrypted image data from the USB memory device 36.

When the encrypted image data read instruction is input (process 401), the encrypted image data is read from the USB memory device 36 and stored in the magnetic disk unit 28 (process 402).

Next, the list of decryption key information stored in the magnetic disk unit 28 is acquired (process and a predetermined hash function is applied with respect to the encrypted image data that is read at that time, so as to create the hash value, that is, the identification information in this case (process 404).

One decryption key information is acquired (process 405), and a judgment is made to determine whether or not the key identification information of the decryption key information and the hash value created in the process 404 match (judgment 406). If the result of the judgment 406 is NO, a judgment is made to determine whether or not unchecked decryption key information exists (judgment 407). If the result of the judgment 407 is YES, the process returns to the process 405, and the remaining decryption key information is processed.

On the other hand, if the result of the judgment 407 is NO, it means that no corresponding decryption key information is found. Hence, in this case, an error display is made on the CRT display unit 29 (process 408), and the process ends in error.

If the key identification information of one of the decryption key information matches the hash value and the result of the judgment 406 is YES, the decryption key data of the decryption key information is acquired and applied as the decryption key when carrying out the decryption process with respect to the encrypted image data so as to generate the image data (process 409).

The generated image data (electronic data) is displayed on the CRT display unit 29 and output, and stored in the magnetic disk unit 28 (process 410), and the process ends.

In order to display and output the encrypted image data that is already stored in the magnetic disk unit 28, a list of the stored encrypted image data may be displayed so as to urge the user to select a desired encrypted image data that is to be displayed. In this case, the encrypted image data that is selected may be subjected to a process similar to that described above.

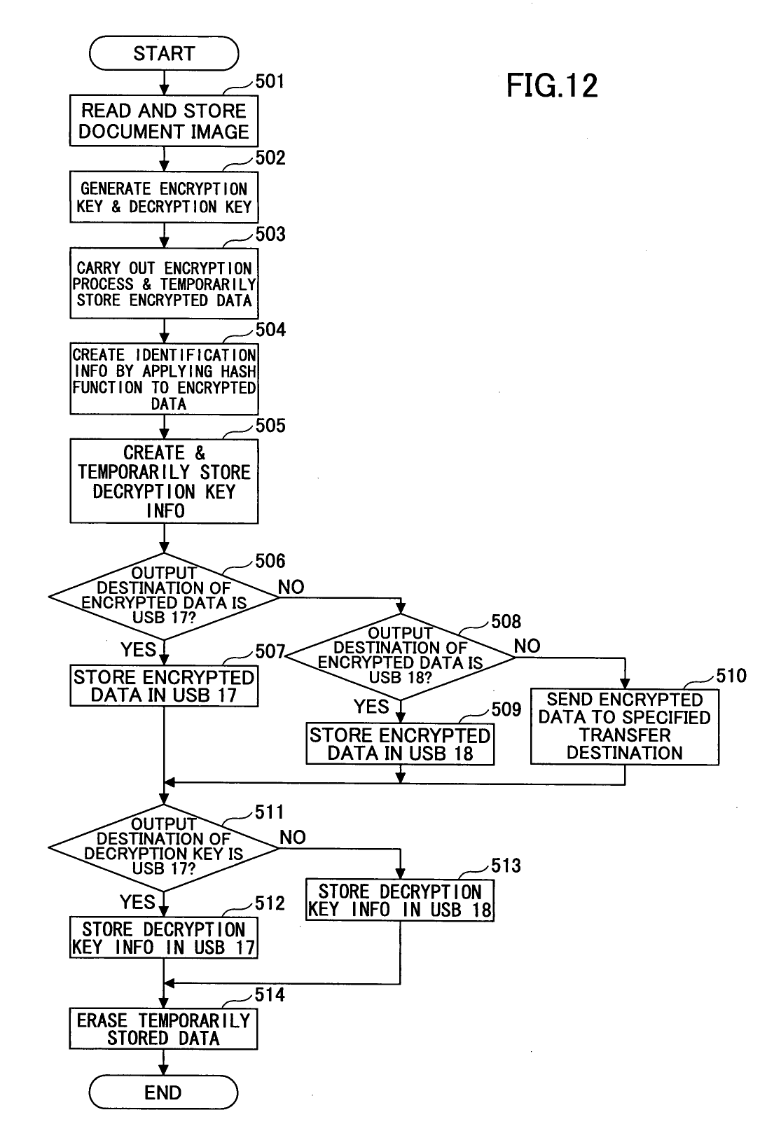

FIG. 12 is a flow chart for explaining another process of the MFP FX. In this case, the encryption method uses both the encryption key and the decryption key in conformance with the public key system.

When the user instructs a document read, the image of the reading document that is set on the scanner 5 is read, and the read image data is temporarily stored in the magnetic disk unit 9 (process 501). Then, the encryption key and the decryption key are generated by the method described above, and are temporarily stored in the parameter memory 3 or the magnetic disk unit 9 (process 502).

Next, the generated encryption key is used to carry out an encryption process with respect to the read image data, and the encrypted image data is temporarily stored in the magnetic disk unit 9 (process 503).

The hash function is applied to the encrypted image data to generate the identification information (process 504), and the decryption key information described above is created and temporarily stored in the parameter memory 3 of the magnetic disk unit 9 (process 505).

Next, an output destination selection screen such as that shown in FIG. 8 is displayed on the operation and display part 7, and urges the user to select the storage locations of the encrypted image data and the decryption key (output destination of the encrypted image data and the output destination of the decryption key). If the “network” is selected as the storage location of the encrypted image data, the user is urged to input the network address of the storage location (for example, the network folder name of the shared storage region in the magnetic disk unit 28 of the work station apparatus WS1).

Thereafter, a judgment is made to determine whether or not the USB memory device 17 is selected as the output destination of the encrypted image data (judgment 506), and if the result of the judgment 506 is YES, the encrypted image data is stored in the USB memory device 17 (process 507).

In addition, if the result of the judgment 506 is NO, a judgment is made to determine whether or not the USB memory device 18 is selected as the output destination of the encrypted image data (judgment 508), and if the result of the judgment 508 is YES, the encrypted image data is stored in the USB memory device 18 (process 509).

If the result of the judgment 508 is NO, it means that the network is selected as the output destination of the encrypted image data. Hence, the encrypted image data is transferred to the specified network address via the local area network LAN (process 510).

Next, a judgment is made to determine whether or not the USB memory device 17 is selected as the output destination of the decryption key (judgment 511), and if the result of the judgment 511 is YES, the decryption key information is stored in the USB memory device 17 (process 512).

In addition, if the result of the judgment 511 is NO, it means that the USB memory device 18 is selected as the output destination of the decryption key. Hence, the decryption key information is stored in the USB memory device 18 (process 513).

When the storage of the encrypted image data and the decryption key information ends, the temporarily stored encrypted image data and decryption key information are erased (process 514), and the process ends.

Therefore, in this embodiment, the keys used for the encryption and the decryption are generated by the MFP, and the MFP is provided with the outputting part (or means) for outputting, to the outside of the MFP, a decryption key that is used for the decryption. As a result, it is unnecessary for the user to make preparations in advance, such as generating the keys, and arbitrary image data can be encrypted and decrypted. Moreover, by relating the encrypted image data and the decryption key, it becomes possible to easily manage the decryption key.

In addition, by relating the decryption key for each electronic document (read image data), and writing the output destination of the decryption key into the USB memory device (removable or portable storage medium), it not only becomes possible to carry the decryption key without the possibility of the decryption key being intercepted, but it also becomes possible to minimize the damage even if the removable or portable storage medium that stores the decryption key is lost.

Furthermore, by writing the output destination of the encrypted image data (electronic data) to a removable or portable storage medium that is different from the removable or portable storage medium to which the output destination of the decryption key is written, it becomes possible to safely carry the electronic data.

By generating a different decryption key for each electronic data, it is possible to minimize the damage even if one key is acquired by a third party who may act maliciously.

In addition, by adding the decryption key to the identification information that is unique to each electronic data, and relating the electronic data and the decryption data, it becomes possible to specify the decryption key that is used for decrypting the encrypted electronic data.

By employing the public key system for the encryption method, it becomes possible to add a digital signature with respect to the electronic data.

Moreover, by employing the common key system for the encryption method, it is possible to encrypt the document after editing the document, as information that is decryptable again using the same key.

A relating part (or means), which is formed by the system control part 1, compares the unique value that is calculated from the encrypted image data by an irreversible process and the identification information that is added to the decryption key, and relates the matching combination. Hence, it is possible to decrypt the encrypted image data without requiring the user to be aware of the kind of key to be used.

By deleting the decryption key from within the MFP after outputting the decryption key, it becomes possible to reduce the possibility of decryption key leak.

In the embodiment described above, if the network is selected as the output destination of the encrypted image data, the MFP FX and the work station apparatus WS communicate directly via the local area network LAN, and the electronic mail may be used in this case for the communication. The LAN transmission control part 13 and the LAN interface 12 form a sending part (or means) configured to send the encrypted image data to the work station apparatus WS by electronic mail. The user must specify the mail address of the destination in this case.

The embodiment described heretofore generates one common key or one set (or pair) of encryption key and decryption key, for each read job. However, it is of course possible to generate one common key or one set of encryption key and decryption key, for a plurality of read jobs. In this case, it is possible to collectively create one encrypted image data from all of the image data.

A serial number for identifying each individual USB memory device is assigned to the USB memory device by the manufacturer, and stored in a suitable storage region of the USB memory device. Hence, the serial number of the USB memory device may be registered in the MFP FX, so as to make only the registered USB memory device usable on the MFP FX.

In this case, it is possible to generate the common key or, the encryption key and the decryption key, based on the serial number of the USB memory device. For example, the serial number of the USB memory device and the number of times the USB memory device is used (number of times used) may be stored, so as to generate the common key or, the encryption key and the decryption key based on the serial number and the number of times used. In this case, it is possible to generate each time a different common key or, different encryption key and decryption key.

In the embodiment described above, the present invention is applied to the work station apparatus WS that is connected to the local area network LAN. However, the present invention is of course applicable to work station apparatuses, personal computers and the like that are connected to other networks that are connected to the local area network LAN via the router apparatus RT shown in FIG. 1.

In the described embodiment, the scanner is used to input the image data. However, the image data input part (or means) may be realized by other part (or means) other than the scanner, such as a part (or means) for inputting the image data stored in the magnetic disk unit, a part (or means) for inputting the image data stored in the USB memory device, and a part (or means) for inputting the image data by a communication with the local area network LAN.

In addition, although the present invention is applied to the MFP in the embodiment described above, the present invention is of course applicable to other image processing apparatuses having similar structures.

This application claims the benefit of a Japanese Patent Application No. 2006-116942 filed Apr. 20, 2006, in the Japanese Patent Office, the disclosure of which is hereby incorporated by reference.

Further, the present invention is not limited to these embodiments, but various variations and modifications may be made without departing from the scope of the present invention.

What is claimed is:

1. An image forming apparatus comprising:
a first generating part configured to generate an encrypted image data by subjecting an input image data to a predetermined encryption process;
a second generating part configured to generate a decryption key that is used when decrypting the encrypted image data, said second generating part generating a different decryption key every time the encrypted image data is generated, and generating an identifier that is uniquely determined based on the encrypted image data; and
an outputting part configured to form decryption key information by adding the identifier to the decryption key, and to store the decryption key information in a first removable storage medium that is connected to the image forming apparatus.

2. The image forming apparatus as claimed in claim 1, wherein said outputting part stores the encrypted image data in a second removable storage medium that is connected to the image forming apparatus.

3. The image forming apparatus as claimed in claim 1, further comprising:
a storage unit configured to store the decryption key information,
wherein said outputting part erases the decryption key information stored in the storage unit after storing the decryption key information in the first removable storage medium.

4. The image forming apparatus as claimed in claim 1, further comprising:
a storage unit configured to store identification information of at least one first removable storage medium,
wherein said outputting part stores the decryption key information only in the first removable storage medium that is identified by the identification information stored in the storage unit.

5. The image forming apparatus as claimed in claim 2, further comprising:
a storage unit configured to store identification information of at least one first removable storage medium and least one second removable storage medium,
wherein said outputting part stores the decryption key information only in the first removable storage medium that is identified by the identification information stored in the storage unit and stores the encrypted image data only in the second removable storage medium that is identified by the identification information stored in the storage unit.

6. The image forming apparatus as claimed in claim 2, wherein said second generating part generates the decryption key based on identification information of at least one of the first and second removable storage media.

7. The image forming apparatus as claimed in claim 1, wherein:
said first generating part generates the encrypted image data using an encryption key;
said second generating part generates, as the decryption key, a common key of a common key cryptosystem; and
said common key is used as the encryption key and the decryption key.

8. The image forming apparatus as claimed in claim 1, further comprising:
a sending part configured to send the encrypted image data to a destination by electronic mail.

9. The image forming apparatus as claimed in claim 1, wherein said second generating part generates the identifier by applying a predetermined message digest generating function with respect to the encrypted image data.

10. The image forming apparatus as claimed in claim 1, further comprising:
a plotter configured to plot an image;
a scanner configured to scan and read a document image; and
a facsimile modem configured to send and receive image data by a facsimile communication.

11. An image reproducing apparatus comprising:
an input part configured to receive encrypted image data and decryption key information by reading at least the decryption key information from a removable storage medium that is connected to the image reproducing apparatus;
a storage unit configured to store the decryption key information;
a generating part configured to generate an identifier that is uniquely determined based on the encrypted image data;
a decrypting part configured to decrypt the encrypted image data using a decryption key of the decryption key information that corresponds to the identifier and to reproduce an original image data; and
an output part configured to output the original image data.

12. The image reproducing apparatus as claimed in claim 11, wherein said generating part generates the identifier by applying a predetermined message digest generating function with respect to the encrypted image data.

13. The image reproducing apparatus as claimed in claim 11, wherein the decryption key is a common key of a common key cryptosystem.

14. The image reproducing apparatus as claimed in claim 11, wherein said output part displays the original image data.

15. The image reproducing apparatus as claimed in claim 11, wherein said input part receives the encrypted image data by electronic mail.

16. An image processing system comprising:
an image forming apparatus comprising:
a first generating part configured to generate an encrypted image data by subjecting an input image data to a predetermined encryption process;
a second generating part configured to generate a decryption key that is used when decrypting the encrypted image data, said second generating part generating a different decryption key every time the encrypted image data is generated, and generating an identifier that is uniquely determined based on the encrypted image data; and
an outputting part configured to form decryption key information by adding the identifier to the decryption key, and to store the decryption key information in a first removable storage medium that is connected to the image forming apparatus; and
an image reproducing apparatus, connectable to the image forming apparatus via a network, comprising:
an input part configured to receive the encrypted image data and the decryption key information by receiving the encrypted image data sent from the image forming apparatus and reading at least the decryption key information from the first removable storage medium that is connected to the image reproducing apparatus;
a storage unit configured to store the decryption key information;
a generating part configured to generate an identifier that is uniquely determined based on the encrypted image data;
a decrypting part configured to decrypt the encrypted image data using a decryption key of the decryption key information that corresponds to the identifier and to reproduce an original image data; and
an output part configured to output the original image data.

17. The image processing system as claimed in claim 16, wherein:
said first generating part of the image forming apparatus generates the encrypted image data using an encryption key;
said second generating part of the image forming apparatus generates, as the decryption key, a common key of a common key cryptosystem; and
said common key is used as the encryption key and the decryption key.

18. The image processing system as claimed in claim 16, wherein said second generating part of the image forming part and said generating part of the image reproducing apparatus generate the identifier by applying a predetermined message digest generating function with respect to the encrypted image data.
